(19) United States
(12) Patent Application Publication
(10) Pub. No.: US 2015/0371288 A1
(43) Pub. Date: Dec. 24, 2015

(54) VIDEO BROCHURE DEVICE AND SYSTEM ENABLED TO PRESENT AND DISPLAY CUSTOMIZABLE AND SHARABLE PRINTED, DIGITAL AND MULTI-MEDIA CONTENT

(71) Applicant: Frank S. MAGGIO, Pinellas Park, FL (US)

(72) Inventor: Frank S. MAGGIO, Pinellas Park, FL (US)

(21) Appl. No.: 14/749,624

(22) Filed: Jun. 24, 2015

Related U.S. Application Data
(60) Provisional application No. 62/016,114, filed on Jun. 24, 2014.

(51) Int. Cl. G06Q 30/02; H04N 5/64

(52) U.S. Cl. CPC G06Q 30/0276; H04N 5/64

(57) ABSTRACT

A system and method are implemented for providing a multi-purpose video brochure that aggregates and integrates technologies and marketing sales tools, in a single form factor, to allow a user to carry, deliver, present, and leave behind an affordable and customizable full-media sales presentation in a single stand-alone unit. A customizable enhanced Video Brochure solution is provided in a form of a cost-effective and quickly ordered and created product. A technology solution is provided that meaningfully diminishes a number and size of individual items required to make an effective presentation to varying sizes of target audiences. A presenter of a typical group presentation is less burdened with preparing for distribution individual sets of handouts or slide presentations, and/or preparing dedicated flash drives, for example, and ensuring that appropriate (compatible) computing and projecting equipment is available in the presentation venue.

This application claims priority to U.S. Provisional Patent Application No. 62/016,114 entitled “Video Brochure Device And System Enabled To Present And Display Customizable And Sharable Printed, Digital And Multi-Media Content,” by Frank S. Maggio, filed in the U.S. Patent and Trademark Office on Jun. 24, 2014, the disclosure of which is hereby incorporated by reference herein in its entirety.

### BACKGROUND

1. Field of the Disclosed Embodiments

This disclosure relates to systems and methods for providing a multi-purpose video brochure that aggregates and integrates technologies and marketing sales tools, in a single form factor, to allow a user to carry, deliver, present, and leave behind an affordable and customizable full-media sales presentation in a single stand-alone unit.

2. Related Art

Advertisers, entrepreneurs, sales people and others make use of varying marketing tools and advertising materials to attract and hold the interest of potential customers, investors and the like. Printed ads in newspapers and monthly periodicals still exist but are often overshadowed by technology-integrated directed advertising materials that are used to supplement live presentations directed a targeted audiences. The advertisers and other users must balance a cost and often a flexibility of the materials, particularly those materials that are designed to convey a specific message to a particularly-targeted group and are intended to be left behind for later review is an impactful way by the potential customers and/or investors, with an expected benefit and/or competitive advantage that is intended to be derived from the particular materials.

Among these technology-integrated materials, a particular class generally referred to as “Video Brochures” has rapidly emerged to become a comparatively powerful marketing tool, often employed by companies seeking to deliver video-enhanced information to prospective purchasers, clients, partners, employees, advertisers, investors, customers and other target audience groups. As currently fielded, a typical Video Brochure combines company pre-printed static panels in a booklet, magazine or brochure form, among other formats, where the individual printed panels typically contain professionally printed and/or branded information, with an embedded video screen and capacity to pre-store and play multi-media content upon an individual recipient opening the Video Brochure.

As currently fielded, there are a number of measurable limitations in the broad acceptance and use of Video Brochures. These limitations include, but are not limited to, the following.

Frequently, in an effort to minimize printing costs, the pre-printed static “backing” or “cover” panels of the Video Brochures are typically identically printed in larger quantities, at or near the time of manufacturing and fabrication of the other components. In this regard, estimates are made of a required “run” of a particular Video Brochure and that number of backing or cover panels are preprinted and generally then unmodifiable without adversely affecting the aesthetically pleasing appearance of those panels. The importance of the aesthetics in creating the proper impression with the customers, investors or others in the target audience generally requires that the company is “stuck with” whatever ultimate design they choose to employ. It is for this reason that such designs are generally finalized only at an ultimate point in time just prior to manufacture of the Video Brochures.

Separately, the videos that are pre-stored in the units are generally “uploaded” en masse at the point of manufacturing in the manufacturing process. Like the cover design, the final video presentation is decided upon and “locked in” just prior to manufacture of the video brochures.

A consequence of the static nature of the cover design for aesthetics and the static nature of the pre-load of the videos for ease of manufacture and for configuration control for the companies intending to use the Video Brochures is that most commonly-available Video Brochures that are in circulation today are not otherwise customizable once produced to contain particular video and print messaging targeting a specified target audience of end users.

Additionally, because of the perceived value of the Video Brochure, a recipient of a Video Brochure frequently does not share the Video Brochure as a unit with others. This “hoarding” of a particular Video Brochure or collection of Video Brochures limits the sharing of the information contained in the Video Brochure through wider spread dissemination of the content. In this regard, it is perceived that Video Brochures, as currently fielded, are not readily adaptable enough to harness and otherwise “viral” nature of the videos that are stored and shared electronically.

Prices charged to companies for orders of Video Brochures are based on a number of factors. These factors include the costs of printing and fabricating the Video Brochures necessary to fill the order on a per-piece profit margin that is comparatively small. Based on this, in order for prices of Video Brochures to fall, for example, to below $50 per unit, quantities in excess of 50 units generally need to be ordered. This places Video Brochures out of the range of affordability for many buyers who would be interested in using video brochures in smaller quantities.

The drive toward affordability has pushed companies that market Video Brochures to outsource much of the fabrication to manufacturing entities outside the United States. This dynamic causes lead times for the manufactured goods to become more protracted, often approaching a month, thereby further limiting access to video brochures for those requiring immediate access to fill in emergent need for an aesthetically pleasing, single form factor leave behind article that professionally conveys the intended advertising, sales, investment or other information to a particularly-relevant target audience.

Despite the above concerns, Video Brochures remain excellent tools to present to individuals, with one screen. This construct in the current implementation necessitates, however, that individual Video Brochures be provided to each member of a target audience. There is generally no manner by which to simply share the recorded video to a group of individuals in the target audience except by providing individual brochures to each member of that group of individuals.

In a current construct, there is generally no simple provision made for integration of collateral materials, including business cards, in the Video Brochure.

### SUMMARY OF DISCLOSED SUBJECT MATTER

In view of the above background, it is clear that there are many potential improvements that could be made to conventional Video Brochures to make them more flexibly customizable, easier to manufacturer, more cost-efficient and dynamically reconfigurable in a manner that retains the aesthetically pleasing and simplified nature of the deliverable in a manner that makes it adaptable for use in presentations to individuals, small groups of individuals, and/or large groups of individuals. In other words, it would be advantageous to provide a customizable and/or user-adaptable Video Brochure solution to address the ability, in an aesthetically pleasing manner, to provide to company users a generic form factor that could be individually customize at a point of use in a manner that provides an economic and flexible presentation platform.

Exemplary embodiments of the disclosed systems and methods may provide a customizable Video Brochure solution in a form of a cost-effective and quickly ordered and created product.

Exemplary embodiments may be designed to implement a technology solution that meaningfully diminishes a number and size of individual items required to make an effective presentation to varying sizes of target audiences. In embodiments, use of an enhanced Video Brochure may afford a company providing a typical group presentation to be less burdened with preparing for distribution individual sets of handouts or slide presentations, and/or preparing dedicated flash drives, for example, and ensuring that appropriate (compatible) computing and projecting equipment is available in the presentation venue.

Exemplary embodiments may provide solutions that address certain shortfalls in conventional Video Brochures in that they may provide a cost effectively produced and customized product that is adaptable to be left behind for subsequent review by an initial recipient and may promote sharing with other interested parties within, or associated with, the initial recipient and/or an entity of which the initial recipient is an officer, employee, contractor, contracting officer, investment advisor or the like.

These and other features, and advantages, of the disclosed systems and methods are described in, or apparent from, the following detailed description of various exemplary embodiments.

### BRIEF DESCRIPTION OF THE DRAWINGS

Various exemplary embodiments of the systems and methods for providing a multi-purpose video brochure that aggregates and integrates technologies and marketing sales tools, in a single form factor, to allow a user to carry, deliver, present, and leave behind an affordable and customizable full-media sales presentation in a single stand-alone unit, according to this disclosure, will be described, in detail, with reference to the following drawings, in which:

FIG. 1A illustrates a general perspective view of an inside of an exemplary open enhanced Video Brochure according to this disclosure;

FIG. 1B illustrates a general perspective view of an outside of an exemplary open enhanced Video Brochure according to this disclosure;

FIG. 2 illustrates a block diagram of an exemplary arrangement of electronic display and presentation components for an enhanced Video Brochure according to this disclosure;

FIG. 3 illustrates a block diagram of an exemplary interface and control system for an enhanced Video Brochure according to this disclosure; and

FIG. 4 illustrates a flowchart of an exemplary method for interacting with an enhanced Video Brochure according to this disclosure.

### DETAILED DESCRIPTION OF EMBODIMENTS

The systems and methods for providing a multi-purpose video brochure that aggregates and integrates technologies and marketing sales tools, in a single form factor, to allow a user to carry, deliver, present, and leave behind an affordable and customizable full-media sales presentation in a single stand-alone unit, according to this disclosure will generally refer to these specific utilities for those systems and methods. Exemplary embodiments described and depicted in this disclosure should not be interpreted as being specifically limited to any particular physical configuration of the enhanced Video Brochure foldable page components and associated flaps and/or any particular configuration of the enhanced Video Brochure audio/visual display and other electronic components, including, but not limited to the power source, external communication, processor and data storage components. It should be recognized that any advantageous use of the systems and methods for enhancing the customizability, adaptability and reusability of a Video Brochure without adversely affecting the aesthetically pleasing nature and utility of the finished product that may benefit from processes, techniques or schemes such as those discussed in detail in this disclosure is contemplated as being included within the scope of the disclosed exemplary systems and methods.

The systems and methods according to this disclosure will be described as being particularly adaptable to producing reusable leave behind form products as enhanced Video Brochures with an objective of providing a single form factor package that is aesthetically pleasing and otherwise very utilitarian. Another objective is to provide the enhanced Video Brochures in a generic form to be locally configured with user-produced or user-procured component, such as particularly-configured labeling, to a particular user's needs as emergent requirements for locally-produced on-call display products emerge. These specific references are meant to be illustrative only in providing a single real-world utility for the disclosed systems and methods, and should not be considered as limiting the disclosed systems and methods to any particular product or combination of devices, or to any particular type of electronically or physically sharable data vehicle. In other words, any commonly-known physical and/or electronic advertising, informing and/or display component vehicles may be incorporated into the overall scheme for generating and reusing the disclosed enhanced Video Brochures and adapting those products according to the specific capabilities discussed in this disclosure.

The disclosed exemplary embodiments of an enhanced Video Brochure may alternatively be referred to as a “TV Pitch Book.” The exemplary products and schemes detailed below are intended to provide a multi-purpose video brochure that aggregates and integrates technologies and marketing sales tools, in a single form factor, to allow a “presenter” to carry, deliver, present, and leave behind an affordable and customizable full-media sales presentation, investment outlook, invention proposal, or other like encapsulated presentation. In non-leave behind embodiments, the TV Pitch Book may present a generic form factor that can be individually “re-formatted” and re-used by erasing/replacing files inside of the embedded electronic components, as well as swapping out removable print media, e.g., decals applied to the form factor that can subsequently be peeled off, to be replaced with newly printed and customized decals without adversely affecting the aesthetically pleasing nature of the finished product for delivery to a particular target audience.

In exemplary embodiments, the TV Pitch Book may combine a series of functionalities in a “video brochure” or “point of sale” form factor, some of which have never been implemented before, allowing the user to maximize the product's appeal and function to a full potential.

Within a single form factor, aided optionally by an embedded or external device enabled to allow Wi-fi, WiGig or other protocol wireless connectivity to the electronic data storage and processing components of the TV Pitch Book, the disclosed embodiments may permit one in possession of the disclosed product to customize and repurpose a robust form of an enhanced Video Brochure with the following range of component benefits.

A video display component may be provided that is connectable, for example, to an external display component. In this manner, the video display component of the enhanced Video Brochure may be viewable by a single observer, or may be connectable for sharing via an external display component with a large target audience. There is virtually no limit to the configuration to the displayable data, which may include, for example, branded presentation materials, instructions, and multi-media video, slide or advanced presentation software prepared presentations, documents, images, music, vCards, and the like.

The physical configuration of the TV Pitch Book may be uniquely arranged to provide a convenient capacity by which to carry and store, for optional distribution, physical printed materials that may duplicate, supplement, enhance, or complement the electronic branded presentation materials. Additionally, the physical configuration may accommodate an ability to carry and store, for optional distribution via shared download, multi-media materials that may duplicate, supplement, enhance, or complement the branded multi-media presentation materials, and to carry, store, trigger, and optionally distribute via Wi-fi, WiGig, other protocol wireless or other web browser-supported, multi-media materials that may duplicate, supplement, enhance, or complement the branded physical and multi-media presentation materials.

In embodiments, key components of the disclosed TV Pitch Book may include in a single form factor, a bi-fold, tri-fold, or multi-page printable booklet, portfolio, brochure or other printable form factor with pages or panels that can house an embedded “media card.” A broad spectrum of electronic components may be provided for facilitating electronic recording and replay of electronic content. The electronic components may include, for example, an embedded screen display of any one of various sizes, often mounted to a rigid mounted surface material (“display card”), including some or all of the following: an LCD, a TFT, or an other display screen; speaker(s) and/or a headphone jack; a power supply (including one or more of a fixed or removable power source, a solar panel, and/or a non-rechargeable or rechargeable battery); a power charging port (i.e., USB or other connection type, for rechargeable batteries); a flash or other format of memory drive with a compatible upload/download access port (i.e., USB, configured as a dual use charging and upload/download port); processor/bios/software to manage the storage and display of videos, images, and sound; and optional control buttons, which allow for user-control of various multi-media actions, power control, volume control and the like.

In embodiments, a power-up and/or an auto-start mechanism may be provided to activate the loaded media display to become operable upon the TV Pitch Book is opened, or to auto-play upon being opened. This function may be accomplished by activating a circuit and/or switch, via a pin or magnetic relay, which may be attached to, or may be part of, the embedded media card, when one of the panels or pages is moved or opened in such a way that the circuit is activated (completed) and the display may be powered up, or videos and/or images within the TV Pitch Book may be auto-played or auto-displayed. In the instance of a magnetic relay, which may be considered a preferable and potentially more reliable/durable mechanism than the “sliding tongue” utilized in greeting cards and similar video brochures. The relay may be activated by adding a metallic material (e.g., a metal disc) on or within the pages or panels that fold upon and over the magnetic relay attached to the display card or other electronic components. When the metal disc within the page contacts or comes within range of the magnetic relay on the display card more other electronic components, the relay may be programmed to close the circuit and as a result, depower/turn off the display and media presentation.

In embodiments, within one of more of the pages or panels, one or more “pocket folder(s)” or folded flap(s) may be provided to hold collateral materials (including printed materials, CD/DVD's or other removable media/data storage component/devices, photos, brochures, pamphlets, and the like). The pocket folder may be inside of a tri-fold panel, such that the TV Pitch Book, in a closed position, will aid in ensuring that the collateral materials do not easily fall out of the TV Pitch Book. Also, within one or more of the pockets or flaps, pre-cut slits may be provided to hold a business card or other identification item inside the slits.

In embodiments, one or more die-cut, removable or permanent decal sheets, which can be printed upon locally by the TV Pitch Book user, so as to customize the TV Pitch Book with the user, client, or other party's greeting, branding, or information may be provided to aid in ensuring that the enclosed multi-media and/or collateral materials are better understood, accepted, and/or more willingly reviewed and consumed by individual members of the target audience, or by the target audience as a group. These die-cut sheets can be custom die-cut so that an area or field within the printed TV Pitch Book page or panel, is left blank (i.e. not pre-printed), so that the decal can be printed upon, and then applied over a compatibly-configured blank area on an outside or inside of the TV Pitch Book, e.g., on what may be considered as “customizable print media zones.” This capacity to locally generate details and/or labeling allows for spontaneous customization of the TV Pitch Book virtually on call as needs for a customized aesthetically pleasing presentation form factor arise. Further, the use of easily-removable decals allows for re-purposing and re-use of the same TV Pitch Book for another recipient audience thereby reducing cost for, and increasing effectiveness of, the products.

In tandem with the video brochure multi-media videography presentations, and customizable/replaceable print media zones, the following features and technologies have been developed/designed to further enhance the functionality and value of the TV Pitch Book. First, an optional “top flap” could be folded OVER collateral materials, such that once closed, and in unison with the pocket flap, could insure that the collateral materials will not fall out of the closed TV Pitch Book, regardless of any orientation in which the TV Pitch Book may be transported and/or held, even when held “upside down.” Second, a removable notepad, with or without a company logo as the letterhead, may be provided. The removable notepad may be, for example, an adhesive-backed, hook and pile mounted or slit and flap mounted mini-pad that may be conveniently available at hand to allow for note taking in presentation environments. For re-purposing, notepads may be removable, and conveniently-attachable to one or more of the panels inside a multi-fold TV Pitch Book.

Myriad configurations of electronic components may be provided to store and play images from, for example, a video or slide presentation. Slides may be paced in varied or consistent increments of time (5-15 seconds each), established by the manufacturer or user/presenter, so that well-conceived slides can be presented and paced in a hands-off manner; alternatively, advance or rewind (“chapter +/−”) buttons may be provided to advance or rewind the presentation as the individual targeted audience recipient may choose to adjust the presentation to his or her liking. When connected to an external display source, an ability to manually control the video presentation may allow a presenter to modify the pace of the presentation, when presented to a larger group target audience. In embodiments, the consistent increments may be shorter increments of time, and for slide images that are more desirable to be displayed for greater increments of time, the identical slide image may be repeated in one or more subsequent increments of time. The transition effect between images may be similar to the “fade” or “appear” effect commonly recognized by those familiar with software-based presentation applications, so that, to a viewer of the slide presentation, it may appear that the duplicate slides are a single slide that remains visible for, in a case of a 4 second increment, 8, 12, 16 and so on seconds instead of 4 seconds.

Component speakers and/or earphone jacks may be provided to allow individualized viewing in even private or quiet settings or viewer environments. An integral earphone jack may be usable so that the audio is only audible to a user utilizing headphones; or, this may allow for the audio channel to be output to an amplifier (for broadcasting in a group environment). The earphone jack may be programmed in such a manner that the speaker volume is muted (or signal diverted) when some external component is connected via the earphone jack, or the earphone jack may simply provide a second channel for the audio signal to be directed.

In embodiments, a reconfigurable Opening Screen may be provided such that during the initial start-up of the display, and in order to quickly provide visible evidence that the display is operable, an indication may be quickly displayed (as would a battery charge display), prior to the display of an auto-play video, image, or slide show. Such an Opening Screen may consist of a static image or file pre-loaded (or created using machine language) within the bios software, which may not be configurable beyond initial programming of the bios, or, the display software can be configured so as to quickly retrieve an image such that the Opening Screen can provide loading instructions, a branded message, clients' logo(s), and the like. The image for presentment of the Opening Screen may be stored in a protected, hidden, or accessible and visible folder or directory for ease of access and replacement, thereby permitting the initial user to lock the opening image for branding purposes if so desired.

Stored electronic content may be provided in any usable format that a company may select. To maintain the fidelity of the stored information, erasure-protected, unlockable directories may be provided to ensure that, when left behind for use/retention by members of the target audience, key presentation elements (videos and/or slide images) cannot be altered, erased, replaced or modified. Using programming language well known to those practiced in the programming art, the directories containing the protected files may be “locked” such that only by pressing a series of buttons in a particular order, within a defined time period, or through other programmed interactions, the protected files may be disclosed/unlocked. The software can be further designed such that ALL directories (indeed, the entire flash memory) are not made visible or accessible until the TV Pitch Book is connected via a USB cable, and a distinct sequence of buttons (i.e. 3 presses of “Play” and 2 presses of “Chapter +”) are activated, in order for the TV Pitch Book memory to be visible by a PC's operating system. In one version of this option, once the USB is unplugged from the TV Pitch Book, the designated (or all) file directories may be re-locked and the TV Pitch Book's memory may no longer be visible, until the sequence is re-initiated. Separately, and option may be provided that after a pre-determined number of viewings, or upon the lapse of a particular timeframe (measured in hours, days, weeks, months or to a particular date and time), the TV Pitch Book's memory may be automatically wiped in order that the electronic data or information provided is no longer available to the target audience user. Virtually all methods by which to segregate, preformat, or store data may be provided within the internal data storage device or the TV Pitch Book's memory. An option could be provided, for example, to allow the target audience user to unlock and download portions or all of the data and/or information to the beneficial use of the target audience user. The TV Pitch Book's memory may include directories for the videos and slide presentations (which may be locked as discussed above) while additional, easy to locate directories capable of storing files may be created to be shared or transmitted, for example, via an internal or external USB-Wi-fi, WiGig or other protocol wireless device that provides wireless access to the permitted directories. In addition to optionally allowing access to the specific folders holding the video and image files used by the TV Pitch Book, the partitioned section of the device might contain: (1) Some or all of the videos, and optionally, additional videos, stored in various file formats and sizes; (2) Some or all of the slide images, and optionally, additional images, stored in various file formats and sizes, including Power Point, Keynote, or other proprietary file formats; (3) Some or all of the leave-behind (or additional) documents, stored in various file formats and sizes; (4) Other files of any kind, including vCard® contact information, music, maps, operating manuals, and information related or unrelated to the presentation; and/or (5) Marketing materials of the presenter, or even of the TV Pitch Book manufacturer or distributor/reseller to promote interest in the TV Pitch Book as a product itself.

User interface with and control of the electronic component in the TV Pitch Book may be provided by a series of manually-operable control buttons including certain specially programmed and/or multi-function control buttons. Control buttons may provide users with the ability to control the multimedia presentation's pace, chapter selection, volume, and also to access and display a slide show of images, or images and text as in a presentation often created within software presentation generating programs. Because control buttons add manufacturing costs, while also possibly utilizing more power, and creating another possible defect or warranty item, by utilizing software, the TV Pitch Book may reduce the number of buttons by increasing the functionality of a more limited number of buttons. Diminishing the number of buttons and consolidating their purpose also serves to reduce the clutter and confusion of the TV Pitch Book, providing less need for a target audience user to become familiar with all of the control features on multiple buttons. In a simple version of the TV Pitch Book, buttons could include
a. Play/Pause Video(s)+1 min. pause=Power Off—This button may play and pause the active video. As a power saving option, pausing the video for an extended period of time (e.g., 1 min) may cause the display to power down. To restart the video, the target audience user may be required to close and reopen the TV Pitch Book. This single button could control multiple videos, which may be stored in a local device memory, and play them in sequence based on file name or some other identified sequential order, or the videos may be programmed to play in a random order.
b. Play/Pause Slide Show(s)—This button may control the launch of a series of images that may be presented and paced over a programmed number of seconds. These images may be randomized and have a consistent or randomized transition effect. Alternatively, the images may include pages of a slide-type presentation, with each image/slide being stored in an alphanumeric or other sequential order, such that the image playing software would play the slides in the alphanumeric or other sequential order, as opposed to a randomized order. In a version of the TV Pitch Book, the pace of the images could be “stalled” and recommenced by pressing the Play/Pause button; alternatively, shared use “Chapter +” and “Chapter −” buttons might remove the slide show from auto-play and auto-sequence, and instead allow the presenter/target audience user to pace the presentation at their own pace by selecting the + or − button.
c. Chapter − and Chapter +—These buttons (with ability to fast forward or rewind videos, respectively, when pressed and held down) may provide a capacity while a video is being played, or a slide show is being presented, to advance to the next video or slideshow (or the end of the current video or slideshow if there is no additional video or slideshow). Pressing and holding a Chapter + button may fast forward the current video being played. While a Slide Show is being played, pressing the Chapter + button may advance to the next slide or image (randomized or in sequence depending on programming). A Chapter − event, while a video is being played or a slide show is being presented, may revert to the start of the current video or slideshow and then to the start of the prior video or slideshow (or the start of the current video or slideshow if there is only one video or slideshow); pressing and holding this button may rewind the current video or slideshow being played. While a slide show is being played, pressing the Chapter − button may revert to the previous slide or image (randomized or in sequence depending on programming).
d. Volume Control Buttons or Knobs− Volume control may be effected through commonly-known mechanisms. By pressing control buttons may modify the volume of a speaker or via the earphones. In a single button version with multiple preset volumes, volume changes may be achieved in order each time the single button is pressed. In one two-button version, the TV Pitch Book could be programmed to start at a modest volume level (i.e. 23 of maximum 30 volume increments), where the volume increment is displayed briefly each time either Volume button is activated. In a version of the TV Pitch Book, a single button may be programmed to adjust the volume to 3 (+/−) volume settings (such as High, Medium, and Low), with the TV Pitch Book commencing at “Medium” volume, and then “cycling” to High, then Low, then Medium, then High, for example. The TV Pitch Book may show the volume level on screen with each press. Alternatively, the volume level could commence at Medium, and then go to High, then back to Medium, then to Low, then back to Medium, in a “return to Medium” pattern with every two presses of the Volume button. Other volume patterns (with more or less stopping points) could be programmed into the Volume button. In one version, holding the Volume button could MUTE the volume and then return to the prior volume when pressed again.
e. Manual Power On/Off—Because the TV Pitch Book contains and holds myriad types of information other than video, images and multi-media information, it may be advantageous for a target audience user to have the display turned off during a portion of the presentation timeframe. Additionally, as display will consume energy, it may be prudent to have the display powered down during a portion of the presentation timeframe. A Power On/Off button may provide immediate power down (or power up) functionality, as opposed to the optional, deferred timeframe of the Pause/Play functionality noted above, and the closing of the TV Pitch Book (which would also make internal pages/panels no longer visible).

As indicated above, an advantage of the disclosed TV Pitch Book may reside in its media sharing technology/capacity. When using the TV Pitch Book, there may be occasions that multiple parties may wish to review the TV Pitch Book presentations at one time. While multiple TV Pitch Books containing similar or identical content may be distributed to multiple members of a target audience, there may be a need to leave behind some or all of the information, but perhaps not all of the TV Pitch Books. Additionally, there may be a need for a target audience user to share some or all of the information with parties that are not present, at a time of the presentation. Such sharing of information may be preferably executed by electronic means including email. In an event that a target audience user or a presenter using a TV Pitch Book wishes to share the design, printed panels or collateral materials, or audio or video images, files, and slide show presentations that are displayed by the TV Pitch Book, various methods for such information sharing may be effected. An accessible digital version of the TV Pitch Book and its presentation materials may be created using “Flip Book” software with Flash, HTML5, or other web-friendly software. A virtual version of the TV Pitch Book may be created and hosted on a website or server. Access to the Virtual TV Pitch Book may be achieved by providing the URL where the item is hosted, which could also be triggered and embedded inside a visually recognizable coded labeling which may be in the form of a QR code. The link and/or QR code may be printed on digital labeling on the TV Pitch Book itself, on collateral materials in the TV Pitch Book, or even inside of one or more of the videos or slide presentations provided by the TV Pitch Book. The Virtual TV Pitch Book may also be password-protected, providing privacy, in the event the information displayed may be proprietary, or otherwise not suitable for sharing with the general public at large. Additionally, or alternatively, a sharable Web App (or “SWApp”) may be provided. A mobile web app (or even native mobile app) may provide target audience users who have access to a related URL link, or link-embedded QR code, access to a web application that may reveal a menu of items related to information in the physical, or virtual, TV Pitch Book. The SWApp can provide the ability to view, and optionally, share via email or other similar communication technology, from any desktop computer or web-connected phone or tablet (or other web-connected displays such as Smart TVs): (1) the Virtual TV Pitch Book, identical or altered for the target audience user; (2) Some or all presentation videos (with a capacity to exclude, for example, proprietary videos); (3) Some or all presentation images (again with a capacity to exclude, for example, proprietary images); (4) Some or all presentation documents (in PDF or HTML, for example); (5) Embedded reactive gaming (using the processes and/or schemes outlined in of U.S. Pat. No. 6,606,745, an HTML5 or similarly formatted web-supported quiz and survey, which poses queries about the contents of the TV Pitch Book, including collateral materials, video, TV Pitch Book panels, and the like); (6) Contact information for the presenter of the TV Pitch Book, or others, which may be further enhanced to allow the target audience user to contact any such party via email, SMS, telephone, or mail; (7) Link to the presenter or other's web site or social media channels; and (8) A link or QR Code to the TV Pitch Book itself, and all of the above items, may be shared with others, so the entire SWApp can be shared with multiple parties.

In embodiments, the TV Pitch Book may include a USB Wi-Fi, WiGig or other protocol connectivity or device component to allow for the sharing of some or all of the digital files or content within the TV Pitch Book, as located and stored in the various directories of the TV Pitch Book, is to allow access to the approved directories and files via the Wi-Fi, WiGig or other protocol technology (familiar to those practiced in the wireless communicating art). Using internal components to effect connection via Wi-Fi, WiGig or other protocol technology, or using an external device which may be connected to the TV Pitch Book via a USB cable, the directories containing the files approved for sharing and viewing may be made visible to target audience users parties who are provided with the IP address of the TV Pitch Book or external Wi-Fi, WiGig or other protocol device. Under such a scenario, for example, a Wi-Fi, WiGig or other protocol-enabled tablet might be able to enter the IP address of the TV Pitch Book or connected external the Wi-Fi, WiGig or other protocol device into a browser, and then may access the videos stored within the TV Pitch Book. By accessing these or other files from external devices, in real time, the contents (such as videos) may be viewed or played on larger screens, for viewing by multiple parties at the same time (such as, in a conference room setting). The files may also be immediately and electronically shared via text, email or other means, when accessed by a device enabled to upload and share files. An HTML, Flash or other version of the Virtual TV Pitch Book may be accessed and displayed. Files such as PDF's could be accessed and viewed (or even printed if a printer is attached to the external network). Files such as presentations could be accessed locally, and immediately inserted into the actual presentation software, allowing a well-paced and true presentation according to the native presentation software to be viewed on an external computer.

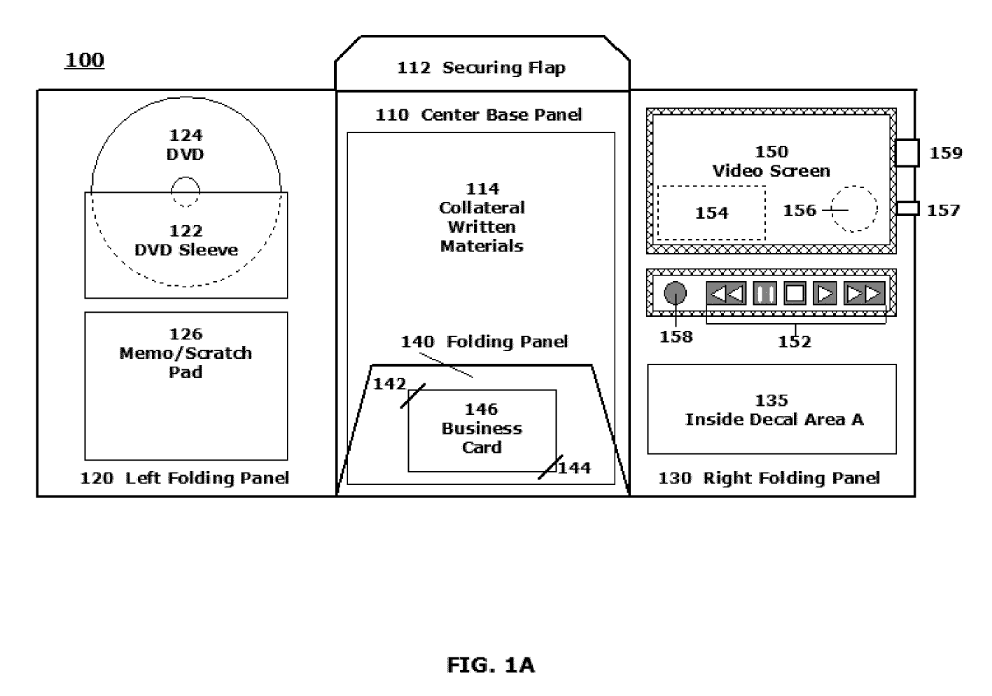

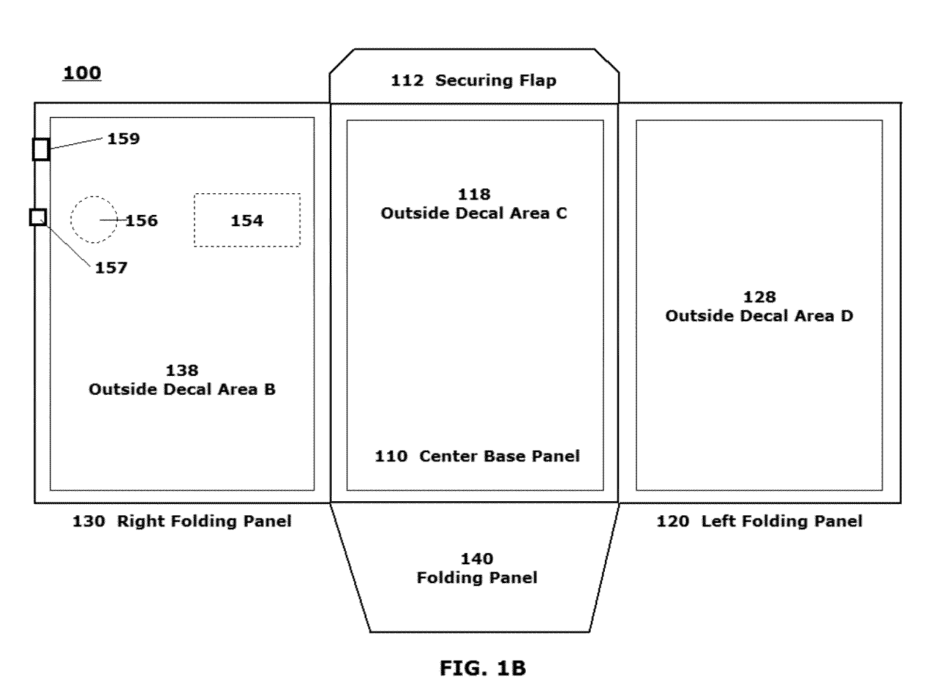

FIG. 1A illustrates a general perspective view of an inside of an exemplary open enhanced Video Brochure 100 according to this disclosure. FIG. 1B illustrates a general perspective view of an outside of an exemplary open enhanced Video Brochure 100 according to this disclosure. As shown in FIGS. 1A and 1B, the exemplary enhanced Video Brochure 100 may include a center base panel 110, a left folding panel 120 and a right folding panel 130 as viewed by a target audience user when the enhanced Video Brochure 100 is in an open configuration (FIG. 1A). In the example shown, a provision is made for collateral written materials 114 to be provided, stored and/or held to the center base panel 110 by upper and lower folding panels or securing flaps 112,140. In this embodiment, slits 142, 144 or cut in the folding panel 140 to accommodate a presenter's business card 146.

The left folding panel 120, in this example, may be particularly configured to accommodate a CD, or DVD 124 in an associated DVD sleeve 122. In alternative embodiments, a thumb drive or other digital data storage device may be accommodated in a compatible sleeve such that, when the exemplary enhanced Video Brochure 100 is closed, the thumb drive or other digital data storage device may be accommodated and held within the closed exemplary enhanced Video Brochure 100. An affixed, or removable, memo/scratch pad 126 may be provided. As indicated above, the memo/scratch pad 126 may be attached to any one or more of a convenient attachment mechanism including adhesives, hook and pile attachments, slot insertion attachment and the like.

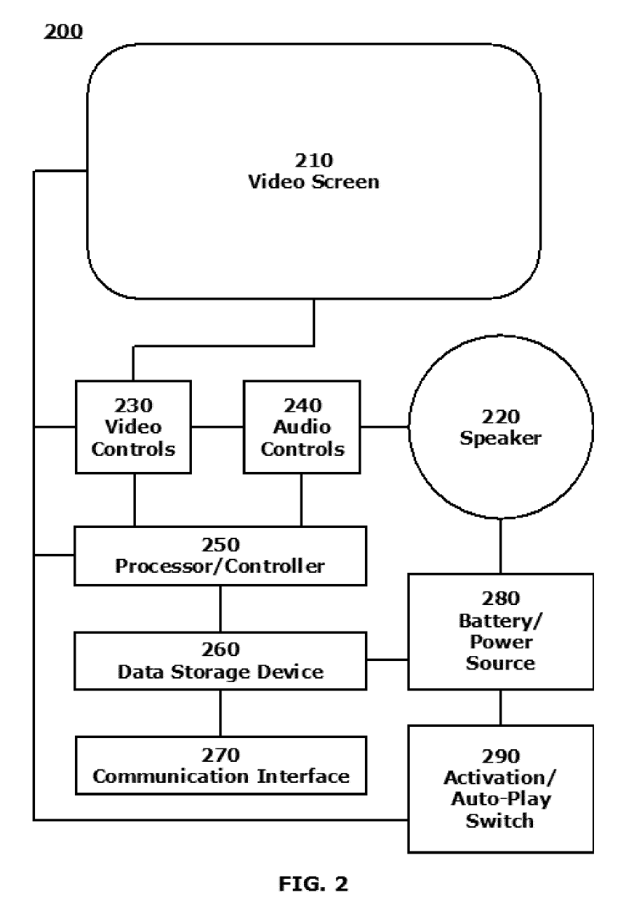

The right folding panel 130, in this example, may be particularly configured to accommodate the electronic display and presentation components. These electronic display and presentation components may include a video screen 150 with associated button controls 152 as described in some detail above, and may include a separate mime control knob 158 to control the volume of the speaker 156, or an earphone or external speaker (not shown) that is connectable to the exemplary enhanced Video Brochure 100 via an earphone or external speaker jack 157. An internal battery or other power source connection 154 may be provided to power the electronic display and presentation components. A communication interface 159 may be provided. The communication interface 159 may be in the form of an antenna to facilitate wireless communication with one or more wireless communicating devices, or may be in the form of, for example, a USB port to provide a wired connection to other communicating devices. More details of an exemplary configuration of the electronic display and presentation components will be provided below with reference to FIG. 2.

The exemplary enhanced Video Brochure 100 may include a plurality of pre-configured decal areas A-D 135, 138, 118 and 128, an appropriate positions on internal and external surfaces of the individual panels that make up the exemplary enhanced Video Brochure 100. As indicated above, these pre-configured decal areas may accommodate compatible decals and/or labeling that may be generated or procured by a user of the exemplary enhanced Video Brochure 100. In embodiments, the decals and/or labeling maybe particularly sized to be accommodated within the pre-configured decal areas. The decals and/or labeling may be adhesively (or otherwise) affixed to the pre-configured decal areas in a manner that secures their positioning for the use of the exemplary enhanced Video Brochure 100 in facilitating presentations to target audience users. The configuration of the pre-configured decal areas, however, also provides a capability whereby the decals and/or labeling may be relatively easily removed from the pre-configured decal areas without adversely affecting those areas. In this manner, the exemplary enhanced Video Brochure 100 may be re-configured, re-labeled and/or re-loaded with a different presentation (and a different “look”) directed at a different target audience.

FIG. 2 illustrates a block diagram of an exemplary arrangement 200 of electronic display and presentation components for an enhanced Video Brochure according to this disclosure. As shown in FIG. 2, the electronic display and presentation components for the enhanced Video Brochure may include a video screen 210, which may be controlled in the manner described above using a series of video controls 230, and a speaker 220, at least a volume of which may be controlled in the manner described above with one or more audio controls 240.

The electronic display and presentation components may include a processor/controller 250 that is programmed to communicate with the video controls 230 and/or the audio controls 242 provide content to the video screen 210 and the speaker 220 according to the user manipulation of the controls. The processor/controller 250 may reference information stored in a data storage device 260 for presentation on the video screen 210. A communication interface 270 may be provided to provide wired or wireless communication between the electronic display and presentation components of the enhanced Video Brochure with a broad array of external communicating, computing, and/or audio/visual display components in the manner described above. A battery/power source 280 to power, as appropriate, any or all of the electronic display and presentation components, including the processor/controller 250, the video controls 230, the audio controls 240, and the video screen 210. The battery/power source 280 a fixed or removable battery, a solar panel, a plug for accommodating, for example, a USB power cord, or any other like device by which power may be provided internally or externally to the enhanced Video Brochure. As described above, an activation/auto-play switch 290 may be provided that causes the electronic components to be activated, and, for example, the video screen 210 to be caused by the processor/controller 25 to display presentation materials when manually activated, or when the enhanced Video Brochure is opened by a target audience user. It should be appreciated that the depiction shown in FIG. 2 is exemplary only, and that many different configurations of the internal components, including adding or removing certain of those internal components is contemplated.

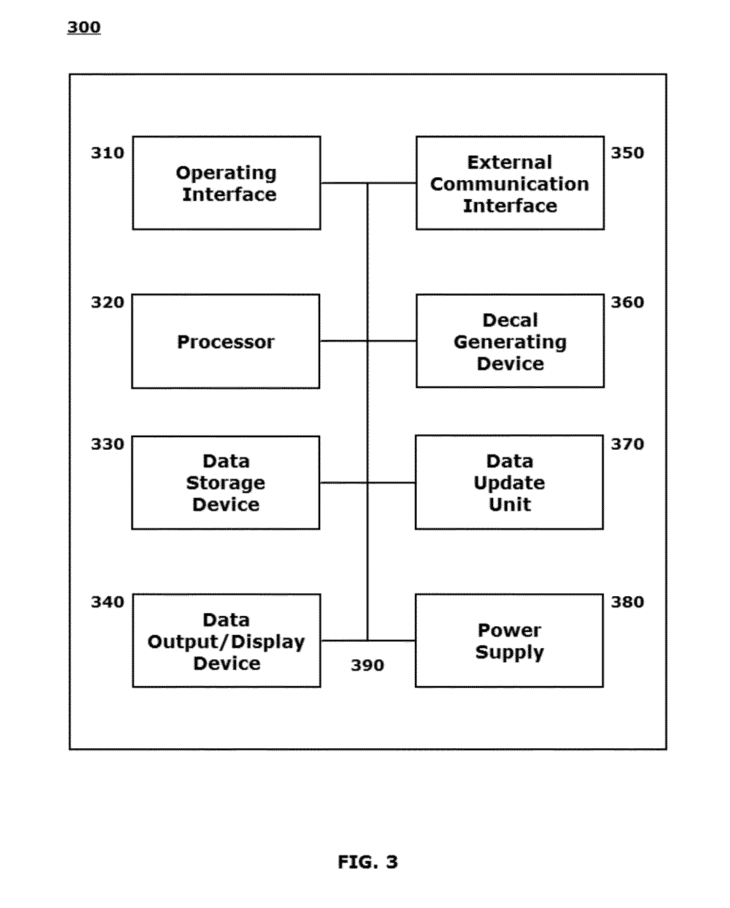

FIG. 3 illustrates a block diagram of an exemplary interface and control system 300 for an enhanced Video Brochure according to this disclosure.

The exemplary interface and control system 300 may include an operating interface 310 by which a user may communicate with the exemplary interface and control system 300. The operating interface 310 may provide a user an opportunity to input information appropriate to generation the decals for, or update of stored video data files associated with an enhanced Video Brochure. The operating interface 310 may be configured as one or more conventional mechanisms common to computing and/or communication devices that may permit a user to input information to the exemplary interface and control system 300. The operating interface 310 may include, for example, a conventional keyboard, a touchscreen with “soft” buttons or with various components for use with a compatible stylus, a microphone by which a user may provide oral commands to the exemplary control system 300 to be “translated” by a voice recognition program, or other like device by which a user may communicate specific operating instructions to the exemplary interface and control system 300.

The exemplary interface and control system 300 may include one or more local processors 320 for individually operating the exemplary interface and control system 300 and for carrying into effect the decal generation, virtual TV Pitch Book interaction and/or stored video and other data manipulation for update to or extraction from enhanced Video Brochure with which the exemplary interface and control system 300 may be in wired or wireless communication. Processor(s) 320 may include at least one conventional processor or microprocessor that interprets and executes instructions to direct specific functioning of the exemplary interface and control system 300, and control of physical and electronic data generation to be transferred to the enhanced video brochure from the exemplary interface and control system 300.

The exemplary interface and control system 300 may include one or more data storage devices 330. Such data storage device(s) 330 may be used to store data or operating programs to be used by the exemplary interface and control system 300, and specifically the processor(s) 320 in carrying into effect the various data generation and/or transfer schemes overseen by the exemplary interface and control system 300. At least one of the data storage device(s) 330 may be used to store information and templates that may be usable to, for example, generate pre-configured decals to be positioned on an enhanced Video Brochure blank as discussed above. At least one of the data storage device(s) 330 may be used to store display an electronic data in one or more files to be selectively transferred from the exemplary interface and control system 300 to the electronic display and presentation components of an enhanced Video Brochure according to the above-described schemes. Through user manipulation of the operating interface 310, the processor 320 may be directed to select particular data stored in the data storage device(s) 330 to assist the user in configuring the enhanced Video Brochure to the particular user's needs in preparation for presentation to a particular target audience. The data storage device(s) 330 may include a random access memory (RAM) or another type of dynamic storage device that is capable of storing updatable database information, and for separately storing instructions for execution of system operations by, for example, processor(s) 320. Data storage device(s) 330 may also include a read-only memory (ROM), which may include a conventional ROM device or another type of static storage device that stores static information and instructions for processor(s) 320. Further, the data storage device(s) 330 may be integral to the exemplary interface and control system 300, or may be provided external to, and in wired or wireless communication with, the exemplary interface and control system 300, including as cloud-based storage components.

The exemplary interface and control system 300 may include at least one data output/display device 340, which may be configured as one or more conventional mechanisms that output information to a user. The data output/display device 340 may be used to indicate to a user available selections for decal generation in the exemplary interface and control system 300 in order that a selected decal scheme may be pushed to a decal generating device 360 that may actually print and output the decals to be placed in appropriate areas on the enhanced Video Brochure. The data output/display device 340 may be separately be a display screen or a projector that may allow a user (presenter) to communicate with an enhanced Video Brochure to acquire information for display from the enhanced Video Brochure and to display up to a broader target audience than may be able to view the displayed information on one or more enhanced Video Brochures.

The exemplary interface and control system 300 may include one or more separate external communication interfaces 350 by which the exemplary interface and control system 300 may communicate with one or more enhanced Video Brochures for carrying into effect the above schemes. At least one of the external communication interfaces 350 may be configured as an input/output port by which the exemplary interface and control system 300 may receive data and information to be translated via the exemplary interface and control system 300 for upload and configuration of the one or more enhanced Video Brochures. As discussed above, the communications with the one or more enhanced Video Brochures may be according to any known wired or wireless communications protocol.

The exemplary interface and control system 300 may include a decal generating device 360 that may actually print and output high-quality decals for positioning on new or re-used enhanced Video Brochure blanks.

The exemplary interface and control system 300 may include a data update unit 370 that may be usable to modify received audio/video data files for use with the enhanced Video Brochures.

The exemplary interface and control system 300 may include some manner of power supply 380 by which to supplement or recharge an onboard power supply in each of one or more enhanced Video Brochures.

It should be recognized that much of the data storage, data processing and power supply/generation for supported enhanced Video Brochures may be provided by the exemplary interface and control system 300 thereby reducing processing overhead, data storage requirements and power supply needs autonomously associated with anyone of the supported enhanced Video Brochures.

All of the various components of the exemplary interface and control system 300, as depicted in FIG. 3, may be connected internally, and to one or more enhanced video brochures That, by one or more data/control busses 390. These data/control busses 390 may provide wired or wireless communication between the various components of the exemplary interface and control system 300, and with the enhanced Video Brochures, whether all of the components of the exemplary interface and control system 300 are housed integrally in, or are otherwise external and connected to the exemplary interface and control system 300.

It should be appreciated that, although depicted in FIG. 3 as an essentially integral unit, the various disclosed elements of the exemplary interface and control system 300 may be arranged in any combination of sub-systems as individual components or combinations of components, integral to a single unit, or external to, and in wired or wireless communication with the single unit of the exemplary interface and control system 300. In other words, no specific configuration as an integral unit or as a support unit is to be implied by the depiction in FIG. 3. Further, although depicted as individual units for ease of understanding of the details provided in this disclosure regarding the exemplary interface and control system 300, it should be understood that the described functions of any of the individually-depicted components may be undertaken, for example, by one or more processors 320 connected to, and in communication with, one or more data storage device(s) 330.

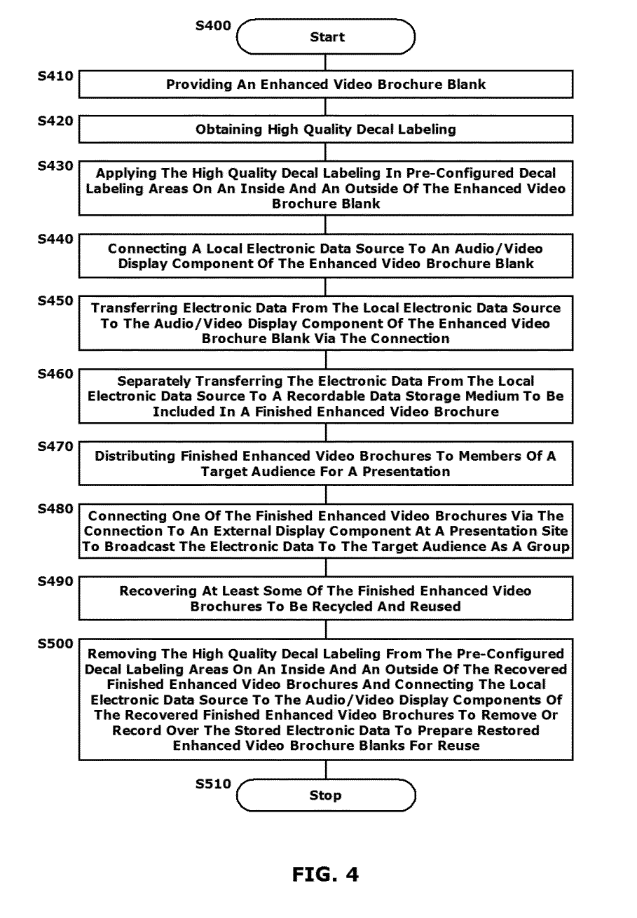

The disclosed embodiments may include an exemplary method for interacting with, and updating, an enhanced Video Brochure. FIG. 4 illustrates a flowchart of such an exemplary method. As shown in FIG. 4, operation of the method commences at Step S400 and proceeds to Step S410.

In Step S410, an enhanced Video Brochure BLANK may be provided substantially configuration shown in exemplary fashion in FIGS. 1A and 1B. Operation of the method proceeds to Step S420.

In Step S420, high-quality decal labeling may be obtained, or locally generated. Operation of the method proceeds to Step S430.

In Step S430, O be obtained or generated high quality decal labeling may be applied in pre-configured decal labeling areas on an inside and/or an outside of the enhanced Video Brochure BLANK. Operation of the method proceeds to Step S440.

In Step S440, the audio/video display components of the enhanced Video Brochure BLANK may be connected to a local electronic data source. Operation of the method proceeds to Step S450.

In Step S450, electronic data may be transferred from the local electronic data source to the audio/video display component of the enhanced Video Brochure BLANK. The completion of steps S430-S450 may turn the enhanced Video Brochure BLANK into a finished enhanced Video Brochure. Operation of the method proceeds to Step S460.

In Step S460, the electronic data may be separately transferred from the local electronic data source to a recordable data storage medium to be included in a finished enhanced Video Brochure. Operation of the method proceeds to Step S470.

In Step S470, finished enhanced Video Brochures may be distributed to members of the target audience for presentation. Operation of the method proceeds to Step S480.

In Step S480, when a presenter chooses to broadcast video content to a larger group of the target audience during the presentation, one of the finished enhanced Video Brochures may be connected via a communication connection to an external display component at a presentation site. Operation of the method proceeds to Step S490.

In Step S490, at least some of the finished enhanced Video Brochures may be recovered to be recycled and reused. Operation of the method proceeds to Step S500.

In Step S500, the finished enhanced Video Brochures may be recycled for reuse by removing the high quality decal labeling from the pre-configured decal labeling areas on an inside and outside of the recovered finished enhanced Video Brochures, and by connecting the local electronic data source to the audio/video display components of the recovered finished enhanced Video Brochures to remove, or record over, the stored electronic data content. Operation of the method proceeds to Step S510, where operation of the method ceases.

The disclosed embodiments may include a non-transitory computer-readable medium storing instructions which, when executed by a processor, may cause the processor to execute all, or at least some, of the steps of the method outlined above.

The above-described exemplary systems and methods reference certain conventional components to provide a brief, general description of suitable operating and presentation scheme implementing environments in which the subject matter of this disclosure may be undertaken for familiarity and ease of understanding. Although not required, embodiments of the disclosure may be provided, at least in part, in a form of hardware circuits, firmware, or software computer-executable instructions to carry out the specific functions described. These may include individual program modules executed by processors.

Those skilled in the art will appreciate that other embodiments of the disclosed subject matter may be practiced in myriad configurations of enhanced Video Brochures for making a broad spectrum of high quality interactive presentations and presentation materials.

As indicated above, embodiments within the scope of this disclosure may include computer-readable media storing computer-executable instructions or data structures that can be read and executed by one or more processors for controlling the presentation processes and schemes. Although one example of a CD or DVD was presented, for example, with respect the description of FIG. 1A, such computer-readable media can be any available media that can be accessed by a processor, general purpose or special purpose computer. By way of example, and not limitation, such computer-readable media can comprise RAM, ROM, EEPROM, CD-ROM, flash drives, data memory cards or other analog or digital data storage device that can be used to carry or store desired program elements or steps in the form of accessible computer-executable instructions or data structures.

Computer-executable instructions include, for example, non-transitory instructions and data that can be executed and accessed respectively to cause a processor, for example, in an enhanced Video Brochure to perform certain of the above-specified display functions. Computer-executable instructions may also include program modules that are remotely stored for access and execution by a processor.

The exemplary depicted sequence of executable instructions or associated data structures represent one example of a corresponding sequence of acts for implementing the functions described in the steps of the above-outlined exemplary method. The exemplary depicted steps may be executed in any reasonable order to carry into effect the objectives of the disclosed embodiments. No particular order to the disclosed steps of the method is necessarily implied by the depiction in FIG. 4, except where a particular method step is a necessary precondition to execution of any other method step. Separately, not all of the depicted steps of the method shown in FIG. 4 need to be implemented in any particular embodiment.

Although the above description may contain specific details, they should not be construed as limiting the claims in any way. Other configurations of the described embodiments of the disclosed systems and methods are part of the scope of this disclosure. It will be appreciated that various of the above-disclosed and other features and functions, or alternatives thereof, may be desirably combined into many other different systems or applications. Also, various alternatives, modifications, variations or improvements therein may be subsequently made by those skilled in the art which are also intended to be encompassed by the following claims.

We claim:

1. A video brochure form factor, comprising:
a foldable multi-page form factor having a plurality of pre-configured decal-accepting portions;
at least one removable labelling configured to be removably affixed to at least one of the plurality of pre-configured decal accepting portions;
a video display unit mounted to a face of a first one of the pages of the form factor such that the video display unit is enclosed within the form factor when the form factor is folded to a closed configuration;
a communication interface for loading data content to be displayed on the video display unit upon activation of the video display unit;
a power supply component that powers the video display unit; and
at least one foldable flap mounted to at least one of a top or a bottom of a second one of the pages that is configured be folded internally to the form factor when the form factor is folded to a closed configuration.

2. The video brochure form factor of claim 1, the at least one foldable flap being configured to accommodate sheets of substrates as additional presentation materials when folded internally.

3. The video brochure form factor of claim 1, the at least one foldable flap being configured hold a business card in a manner that the business card is displayed when the form factor is unfolded to an open configuration.

4. The video brochure form factor of claim 1, further comprising a data storage medium accommodating sleeve mounted to an internal face of at least one of the plurality of pages to securely accommodate a pre-recorded removable data storage medium.

5. The video brochure form factor of claim 4, the data storage medium being of a compact disc or a digital video disc.

6. The video brochure form factor of claim 1, further comprising a processor associated with the video display unit that is programmed to interpret instructions received in the processor for displaying particular content on the video display unit.

7. The video brochure form factor of claim 6, the processor receiving commands from one of a plurality of user activated control buttons associated with the processor.

8. The video brochure form factor of claim 6, the processor being programmed to respond to the closing of a circuit that occurs automatically when electrical contacts between the power supply and the video display unit are made to complete an electrical circuit when the folded form factor is manipulated from a closed position to an open position.

9. The video brochure form factor of claim 8, the electrical contacts comprising a metal disc and a magnetic relay, the electrical circuit being completed when the metal disc is brought within range of the magnetic relay as the foldable form factor is unfolded.

10. The video brochure form factor of claim 9, the processor being programmed to command the video display unit to display a static logo page initially upon the electrical circuit being completed.

11. The video brochure form factor of claim 1, further comprising at least one of an audio speaker and an audio signal output jack.

12. The video brochure form factor of claim 11, a volume of sounds from the audio speaker or from an audio device connected via the audio signal output jack being controlled by a volume control component mounted to the form factor.

13. The video brochure form factor of claim 1, the communication interface being configured to complete a communication connection with a data content source for at least one of the loading of the data content or sharing of the data content.

14. The video brochure form factor of claim 1, the communication interface being configured to complete a communication connection with an external display component, the external display component being configured to be viewed by a plurality of viewers at once.

15. The video brochure form factor of claim 1, the communication interface being configured to function as the power supply component.

16. A method for providing a presentation via a video brochure form factor, comprising:
providing a foldable multi-page form factor comprising:
a plurality of pre-configured decal-accepting portions;
a video display unit mounted to a face of a first one of the pages such that the video display unit is enclosed within the form factor when the form factor is folded to a closed configuration;
a communication interface for loading data content to be displayed on the video display unit upon activation of the video display unit;
a power supply component that powers the video display unit; and
at least one foldable flap mounted to at least one of a top or a bottom of a second one of the pages that is configured be folded internally to the form factor when the form factor is folded to a closed configuration;
affixing at least one removable labelling to at least one of the plurality of pre-configured decal accepting portions;
loading the data content via the communication interface; and
activating the video display unit by closing a circuit automatically when electrical contacts between a power supply and the video display unit are made to complete an electrical circuit when the folded form factor is manipulated from a closed position to an open position.

17. The method of claim 16, further comprising loading cooperatively configured receptacles in the form factor with at least one (1) sheets of substrates as additional presentation materials, (2) a business card, and (3) a pre-recorded removable data storage medium.

18. The method of claim 16, further comprising:
controlling display of information on the video display with a plurality of user activated control buttons associated with a processor in the form factor; and
controlling a volume of sounds from at least one of an audio speaker and an audio device connected via an integrated audio signal output jack in the form factor by manipulating a manual volume control device mounted to the form factor.

19. The method of claim 16, the electrical contacts comprising a metal disc and a magnetic relay, the electrical circuit being completed when the metal disc is brought within range of the magnetic relay as the foldable form factor is unfolded.

20. The method of claim 16, the communication interface being configured to at least one of (1) complete a communication connection with an external display component, the external display component being configured to be viewed by a plurality of viewers at once, and (2) function as the power supply component.
